(19) United States
(12) Patent Application Publication
(10) Pub. No.: US 2025/0020534 A1
(43) Pub. Date: Jan. 16, 2025

(54) Vacuum leak detector with multistage vacuum pump and integrated gas-specific gas sensor and method for producing a vacuum leak detector

(71) Applicant: INFICON GMBH, Köln (DE)

(72) Inventors: Carsten STRIETZEL, Köln (DE); Ivan BOKANOVIC, Köln (DE); Hjalmar BRUHNS, Köln (DE)

(73) Assignee: INFICON GMBH, Köln (DE)

(21) Appl. No.: 18/715,899

(22) PCT Filed: Dec. 6, 2022
(86) PCT No.: PCT/EP2022/084572

§ 371 Date: Jun. 3, 2024

(30) Foreign Application Priority Data
Dec. 8, 2021 (DE) 10 2021 132 252.9

(51) Int. Cl. G01M 3/20; F04D 17/16; F04D 19/04

(52) U.S. Cl. CPC G01M 3/205; F04D 17/168; F04D 19/042

(57) ABSTRACT

A gas-specific vacuum leak detector has a multi-stage vacuum pump and a gas-specific gas sensor. The gas sensor is an integral part of the vacuum pump and is thereby adapted to detect a specific gas within the vacuum pump.

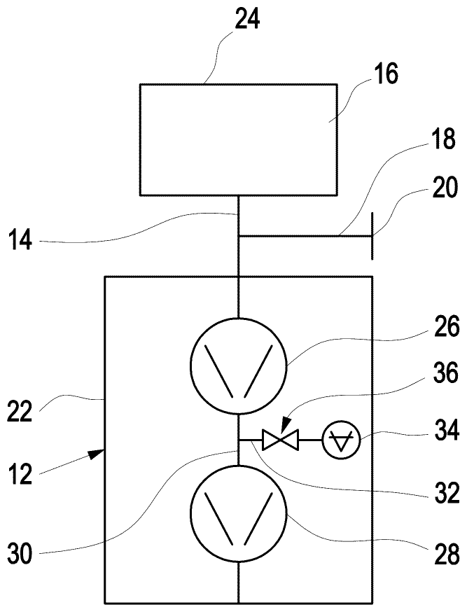

### CROSS-REFERENCE TO RELATED APPLICATIONS

The present application is a national stage application filed under 35 U.S.C. § 371 of PCT Application No. PCT/EP2022/084572, filed on Dec. 6, 2022, which claims priority to German patent application 102021132252.9, filed on Dec. 8, 2021, the entire contents of all of which are incorporated by reference herein.

### BACKGROUND OF THE DISCLOSURE

### 1. Field of the Disclosure

The disclosure relates to a gas-specific vacuum leak detector with a multistage vacuum pump and a gas-specific sensor.

### 2. Description of Related Art

In conventional vacuum leak detectors, a test chamber is connected to a vacuum pump to draw gas from the test chamber. A test object is located in the test chamber or the chamber itself is the test object. If the test object has a leak, gas escapes from the test object into the test chamber and is supplied to a gas sensor connected with the test chamber. The gas sensor conventionally is a device separate from the vacuum pump, e.g. in the form of a total pressure gauge or in the form of a gas-type dependent, i.e. gas-specific sensor such as e.g. a mass spectrometer, an optical sensor, an IR absorption unit or a metal oxide sensor.

For leak detection systems with multistage vacuum pumps it is known to connect a separate gas detector to a port of the vacuum pump, for example to the gas inlet or to an intermediate gas inlet between two adjacent pump stages.

### SUMMARY OF THE DISCLOSURE

It is an object of the present disclosure to provide an improved, more economical and technically simplified gas-specific vacuum leak detector, as well as a corresponding method for producing a gas-specific vacuum leak detector.

According to the disclosure, the gas-specific gas sensor, i.e. a sensor reacting selectively and possibly adjustably to a special gas type, is an integral part of the vacuum pump and is thus configured to detect a specific gas inside the vacuum pump. Accordingly, the gas sensor not only detects a gas inside the test chamber or inside a line path connected to the vacuum pump or a pump stage of the vacuum pump, but directly inside the vacuum pump.

According to the method of the present disclosure for producing a gas-specific vacuum leak detector, a gas-specific gas sensor is integrated into a multistage vacuum pump such that the gas-specific gas sensor is an integral part of the vacuum pump and is thereby configured to detect a specific gas inside the vacuum pump.

Advantageously, the plurality of pump stages of the vacuum pump are enclosed by a common housing in which also the gas sensor is arranged. The housing of the vacuum pump is different from the housing of the test chamber and/or the housing of a possible separate gas detector.

The vacuum pump may have a port for a test chamber or for a test object. The port is preferably provided on the housing.

As an alternative or in addition, the housing of the vacuum pump can comprise another port for a separate gas detector.

In the conveying direction of the vacuum pump, a branch can be provided upstream of at least one of the pump stages, said branch being connected to the gas sensor. The branch can be provided with a selectively actuatable stop valve. The valve may be provided with a valve controller which is configured to actuate the valve as a function of the speed or the power consumption of the vacuum pump or at least one pump stage of the vacuum pump.

The sensor can be a membrane sensor, a semiconductor or metal oxide sensor, a mass spectrometer, a CO₂ sensor, an infrared absorption sensor or a gas-specific emission-spectroscopic sensor. The respective sensor should preferably be able to detect at least one test gas typically used for leak detection, such as e.g. hydrogen, helium, CO₂ and/or hydrocarbon, with sufficient sensitivity.

The vacuum pump may be a multistage scroll pump, a rotary vane pump, a roots pump or a screw stage pump.

### BRIEF DESCRIPTION OF THE DRAWINGS

Hereinafter, an embodiment of the disclosure will be explained with reference to the FIGURE.

The FIGURE a schematic illustration according to the present disclosure.

### DETAILED DESCRIPTION OF THE DISCLOSURE

A multistage vacuum pump 12 is connected to a test chamber 16 via a connection line 14 in order to evacuate the test chamber 16. The test chamber 16 either contains an object to be tested for tightness or is itself the object to be tested for tightness. The connection line 14 is provided with a separately closable branch 18 having a port 20 to which a gas detector can be connected.

The vacuum pump 12 has a housing 22 different from the housing 24 of the test chamber 16 and the housing of a possible, separate gas detector which may be connected to the port 20, for example. The vacuum pump 12 is a multistage vacuum pump with two pump stages 26, 28, which are each also arranged inside the common housing 22. The two pump stages 26, 28 are connected via a channel 30 having a branch 32 to which a gas-specific gas sensor 34 is connected. The branch 32 is provided with a stop valve 36 which can be closed via a valve controller not illustrated in the FIGURE. The valve 36 is arranged between the two pump stages 26, 28 and the gas sensor 34, in order to gas-technically separate the gas sensor 34 from the two pump stages 26, 28.

The gas sensor 34 is a membrane sensor (e.g. a WISE Technology Sensor). The stop valve 36 is closed in a normal state and automatically opens when a predefined speed or power consumption of the two pump stages 26, 28 is exceeded. The sensor 34, the stop valve 36, the branch 32 and the two pump stages 26, 28 are each integral parts of the vacuum pump 12 and are thus arranged inside the common housing 22 surrounding these components.

1-9. (canceled)

10. A gas-specific vacuum leak detector comprising:
a multistage vacuum pump; and
a gas-specific sensor,
wherein the gas sensor is an integral part of the vacuum pump, and
wherein the gas sensor can detect a specific gas in the vacuum pump.

11. The vacuum leak detector according to claim 10, wherein the multistage vacuum pump has a plurality of pump stages surrounded by a common housing in which the gas sensor is also arranged.

12. The vacuum leak detector according to claim 10, wherein the multistage vacuum pump has a port for a test chamber or a test object.

13. The vacuum leak detector according to claim 10, further comprising a branch connected to the gas sensor at a location upstream of at least one stage of the multistage vacuum pump relative to a conveying direction of the multistage vacuum pump.

14. The vacuum leak detector according to claim 13, wherein the branch has a selectively actuatable stop valve.

15. The vacuum leak detector according to claim 14, wherein the selectively actuatable stop valve has a valve controller configured to actuate the valve as a function of a speed or a power consumption of the multistage vacuum pump.

16. The vacuum leak detector according to claim 10, wherein the sensor is a membrane sensor, a semiconductor or metal oxide sensor, a mass spectrometer, a CO₂ sensor, an infrared absorption sensor, or a gas-specific emission-spectroscopic sensor.

17. The vacuum leak detector according to claim 10, wherein the multistage vacuum pump is a multistage scroll pump, a rotary vane pump, a roots pump, a screw stage pump, or a turbomolecular pump.

18. A method for producing a gas-specific vacuum leak detector, the method comprising:
integrating a gas-specific gas sensor into a multistage vacuum pump so that the gas sensor is an integral part of the vacuum pump and is thereby adapted to detect a specific gas within the vacuum pump.
